(19) United States
(12) Patent Application Publication
(10) Pub. No.: US 2005/0091273 A1
(43) Pub. Date: Apr. 28, 2005

(54) Integrated control and data manager for i2 demand manager

(75) Inventor: Kenneth P. Merritt, Poughkeepsie, NY (US)

Correspondence Address: DELIO & PETERSON, LLC, 121 WHITNEY AVENUE, NEW HAVEN, CT, 06510, US

(73) Assignee: International Business Machines Corporation, Armonk, NY (US)

(21) Appl. No.: 10/693,809

(22) Filed: Oct. 24, 2003

(51) Int. Cl. G06F 17/00

(52) U.S. Cl. 707/104.1

(57) ABSTRACT

A method for generating a set of tables and programs to automate the creation and recreation of the i2 Demand Manager database application, as well as the loading of data into the application. The creation and recreation is done quickly and error-free.

### BACKGROUND OF THE INVENTION

1. Field of the Invention

The present invention relates to information processing using multidimensional databases, and particularly to automatically creating, retrieving, and formatting data for an i2 Demand Manager Application.

2. Description of Related Art

A database is a collection of data, usually pertaining to some reasonably well-defined purpose. The data in a database is typically stored, retrieved, and modified by a special type of computer program, generally referred to as a database management system (DBMS). In order to say that data has been stored in a database, as opposed to just being stored, certain conditions are typically satisfied. The data typically has a known format, which is defined by metadata. Metadata is generally understood as data about data.

Relational database management systems are well known in the prior art. A relational database management system is a type of database management system that stores information in tables, rows and columns, and conducts searches. A relational database may use matching values in two tables to relate information in one table to the information in the other table.

A product/application called Demand Manager from i2 Technologies Corporation dynamically retrieves data from DB/2 databases for viewing by users. The i2 application simulates a multi-dimensional, hierarchical database, where the user must design and create each dimension and hierarchy based on a selected business process. The user must define each data measure based upon which dimensions of the database the data measure pertains to, as well as how far down the hierarchy the data is to be loaded and ultimately viewed. A multidimensional database can organize numeric data along a plurality of dimensions, for example, product, geography, and measures dimensions. The product dimension may reflect the hierarchy of products in the organization. The geography dimension typically reflects locations of the corporate organizations, sales districts, zip codes, and the like. The measures dimension presents detailed data on income, revenue, expenses, and quantities, among other related factors. The combination of these forms a coordinate set in the i2 Demand Manager system, such as, “Product A,” “US,” and “Expense.” The multidimensional database is able to retrieve a numeric or alphanumeric value that represents an aggregated value of the specified measure for the specified dimensional coordinates.

From a user perspective, an important feature of database management software is the user interface. The inputted data must be in a predefined format, and loaded prior to being used. The data is generally organized in a specific manner with each data measure tagged to a key so that the Demand Manager application can properly display the data. Currently, the maintenance and loading of the data, as well as maintenance and generation of the keys, is a manually intensive, error prone process. The present invention eliminates manual data entry, and allows for simplified modifications to the data, and ease of data retrieval.

The i2 Demand Manager is a browser-based application that lets a user view data, perform interactive forecasting, and conduct exception analysis for applications that require multi-dimensional analytical services. Through i2 Demand Manager, one can view a spreadsheet that contains plan exceptions, historical data, such as sales in dollars, sales in units, and the like, or forecast projections for products within geographical locations and time periods of the user's choice, displayed and aggregated simultaneously to various levels of detail, for example, in increments of weeks, months, or quarters. Currently, one of the most challenging problems associated with the i2 Demand Manager is the creation of a data entry mechanism that allows users to efficiently load and maintain all the necessary data measures for operation.

To aid in the understanding of the present invention, a glossary of terms is included herein.

Measure—A measure is a gauge or indicator of a product's past, current or forecasted future activity. For example, the measure “backlog” is a gauge of the past or current backlog of a product. The measure “supply request forecast” is a gauge of the forecasted, future supply requested of a product. Other typical measures include “shipments,” “orders,” and “cancellations,” to name a few. A measure is keyed to any of the dimensions defined in the database. FIG. 1 depicts a screen display 10 for particular measures 12 as viewed from an i2 database management system.

Metadata—Metadata describes how the structure and calculation rules are stored, plus, optionally, additional information on data sources, definitions, transformations, quality, date of last update, user privilege information, and the like.

Dimension—A dimension is fundamental to the application. It identifies characteristics of the data in a database, such as geography, by which all the data in the database can be grouped and retrieved. The Demand Manager database may contain any number of dimensions, with the three most common being product, time and geography. Each dimension contains one or more hierarchies of nested levels. For example, in FIG. 2, the geography dimension 20 is selected, and the top level of the geography hierarchy 22, World, contains four members at the subordinate geography level 24: Americas, AP, DIV, EMEA. The Americas Geography contains four lower level members, Americas Plan, Canada, LA, and USA at the sub-geography level.

Member—A member is an element in a given level of a hierarchy. For example, as depicted in FIG. 2, Canada 26 and USA 28 are members of the sub-geography level of the geography dimension.

Data Intersection—Data is managed at the intersection of one or more members for each dimension for which the data is keyed. For instance, if, for example, “backlog” is stored at the Region level in the geography dimension shown in FIG. 2, or the SOS level 30 of the Manufacturing dimension 32 depicted in FIG. 3, or the Partial Week level 40 of the time dimension 42 depicted in FIG. 4, then a specific data intersection is named, that is, a specific region, SOS, or partial week that yields an actual number in the spreadsheet. One such example includes the following designations: Region=USA, SOS=Poughkeepsie, N.Y., and Partial Week=February 10-16. In the Demand Manager spreadsheet, the data retrieved from each database intersection is displayed in a spreadsheet cell.

After the scope of a particular session has been defined, Demand Manager displays a spreadsheet that contains the data measures with their respective data, dimension levels, and the members selected during the scope definition period. FIG. 5 depicts a partial sample of a spreadsheet 50 from the i2 Demand Manager with selected data.

There are two DB/2 databases that make up the Demand Manager database: the persistence database, also known as i2dm in the i2 documentation, which contains the metadata, including definitions of the database, level, level instances, scopes, sessions, security, and the like; and the measure database, also known as i2dmdb in the i2 documentation, which contains the data for the specific intersections of each measure. Historical data, generally non-modifiable, is loaded into the measure database from legacy systems. Forecast data, which is generally modifiable data in Demand Manager, gets automatically inserted into the measure database upon user entry.

These two databases must be built and loaded with data on a periodic basis. The present invention addresses the storing, loading, and retrieving of this data. Specifically, the present invention automates the creation of all the inputs to building the database, and to loading of data into the measure data tables.

Bearing in mind the problems and deficiencies of the prior art, it is therefore an object of the present invention to provide an integration control and data manager for automatically creating, retrieving, and formatting data for an i2 Demand Manager Application

It is another object of the present invention to provide an integration control and data manager for eliminating errors from manual data entry.

A further object of the invention is to provide an integration control and data manager for modifying and updating data files for input to an i2 Demand Manager database.

Still other objects and advantages of the invention will in part be obvious and will in part be apparent from the specification.

### SUMMARY OF THE INVENTION

The above and other objects, which will be apparent to those skilled in art, are achieved in the present invention, which is directed to in a first aspect, a method for automating the creation and maintenance of an i2 Demand Manager database, comprising: building i2 Demand Manager persistence and measure databases, including creating SQL and generating a first set of programs to retrieve data from source systems; storing the data in configuration tables; activating a second set of programs to read the configuration tables and create XML files and SQL statements; formatting the data based on defined data measures; and loading the data into the i2 Demand Manager database. Loading the data further comprises generating control tables to control the loading, including determining which of the data measures are to be loaded and when loading occurs. The configuration tables further include: control, product, dimension, level, hierarchy, user ID, logging, and security tables. The method further comprises running a script to execute the first and second set of programs. The XML files are input into an i2 utility to build the i2 Demand Manager database. The programs input measure data for the measure database, the measure data residing in staging tables and fact tables. The method also includes inputting spreadsheet information into the product tables, dimension tables, level tables, and hierarchy tables. A warehouse manager program facilitates data storage and retrieval. The persistence database is built using an i2 utility program, such that the configuration files are inputs to the i2 utility program. The XML files are referenced in the configuration files, converting the XML files to meta data, and providing the i2 utility program with the SQL statements. The method further includes installing the configuration files including installing information for location for middleware components and DB/2 aliases. The XML file defines a skeleton of the database, including dimension, levels, and measures. Loading the data into the i2 Demand Manager database includes generating a load file for loading hierarchy instances and targets, and placing the load file in an administrative directory. The dimension table includes: a master dimension source table; a table holding views; a table holding hierarchy level information for each dimension; a table containing information to each level; a table containing information to each measure; a table holding lookup information for location; a table holding information for level members; a table holding data for intersections of the database; tables containing user ID, password, and security information; and tables holding each process and each event of each process. The method further includes generating measure configuration tables comprising: generating a master measure source table; holding dimensionality information for each of the measures; addressing level members; and generating measure data tables. Programs are generated to read the master measure source table and the dimensionality information, the programs automatically generate SQL for the tables. Logger tables are generated to log process or program execution, data loading tables, and forecast measure initialization tables.

In a second aspect, the present invention is directed to a computer program product comprising: a computer usable medium having computer readable program code means embodied therein for causing a method for generating a set of tables and programs to automate the creation and recreation of an i2 Demand Manager database application, the computer readable program code means in the computer program product comprising: computer readable program code means for causing a computer to effect building i2 Demand Manager persistence and measure databases, including creating SQL and generating a first set of programs to retrieve data from source systems; computer readable program code means for causing a computer to effect storing the data in configuration tables during the building; computer readable program code means for causing a computer to effect activating a second set of programs to read the configuration tables and create XML files and SQL statements; computer readable program code means for causing a computer to effect formatting the data based on defined data measures; and computer readable program code means for causing a computer to effect loading the data into the i2 Demand Manager database. The computer program product includes computer readable program code means for generating the configuration tables further comprising: control, product, dimension, level, hierarchy, user ID, logging, and security tables. The computer program product further includes computer readable program code means for inputting the XML files into an i2 utility to build the i2 Demand Manager database.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a screen display for particular measures as viewed from an i2 database management system.

FIG. 2 depicts a screen display of hierarchies of nested levels for a given dimension, as viewed from an i2 database management systems.

FIG. 3 depicts the SOS level of the Manufacturing dimension for an example i2 Demand Manager spreadsheet.

FIG. 4 depicts the Partial Week level of the Time dimension for an example i2 Demand Manager spreadsheet.

FIG. 5 depicts a partial sample spreadsheet from the i2 Demand Manager with selected data.

FIG. 6 depicts the Integrated Control and Data Manager of the present invention.

FIG. 7 depicts the XML generation flow for building a database for the Integrated Control and Data Manager.

FIG. 8 depicts a sample of data of the master dimension source configuration table.

FIG. 9 depicts a sample portion of the dim.dimension_view configuration table of the present invention.

FIG. 10 depicts a sample portion of the dim.level_hierarchy configuration table.

FIG. 11 depicts a sample portion of the dim.level_master configuration table of the present invention.

FIG. 12 depicts a sample portion of the measure.measure_master configuration table of the present invention.

FIG. 13 depicts a sample portion of the measure.measure_dimensionality configuration table.

FIG. 14 depicts a sample portion of a measure.measure_lookup configuration table.

FIG. 15 represents an example of a level table, specifically, the lvl.st_lvl_mfg_month table.

FIG. 16 depicts a sample measure data table file of the present invention.

FIG. 17 depicts a sample portion of the logger.log_process table.

FIG. 18 depicts a sample portion of the logger.log_process_events table.

### DESCRIPTION OF THE PREFERRED EMBODIMENT(S)

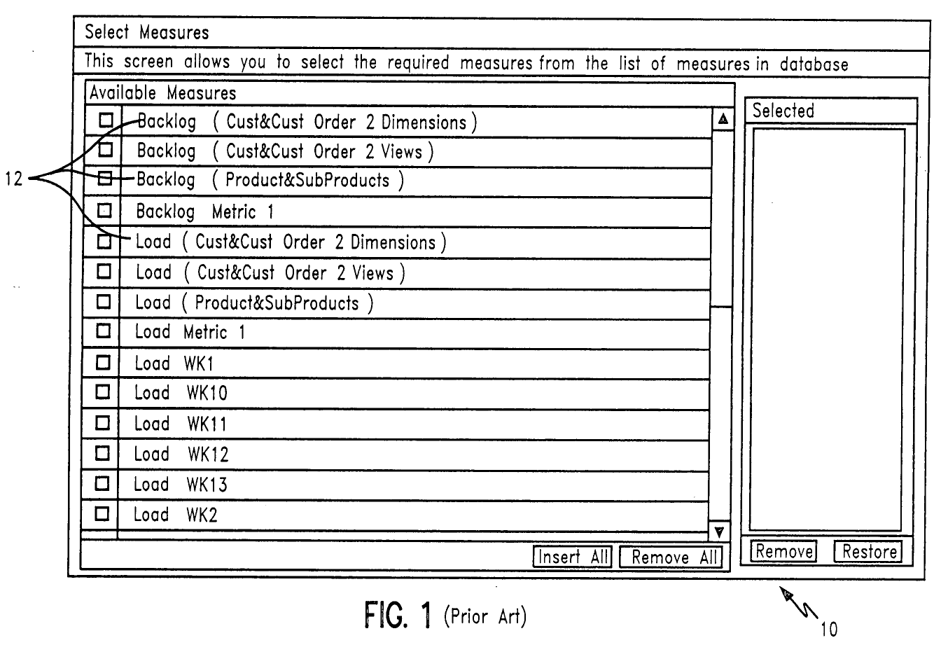

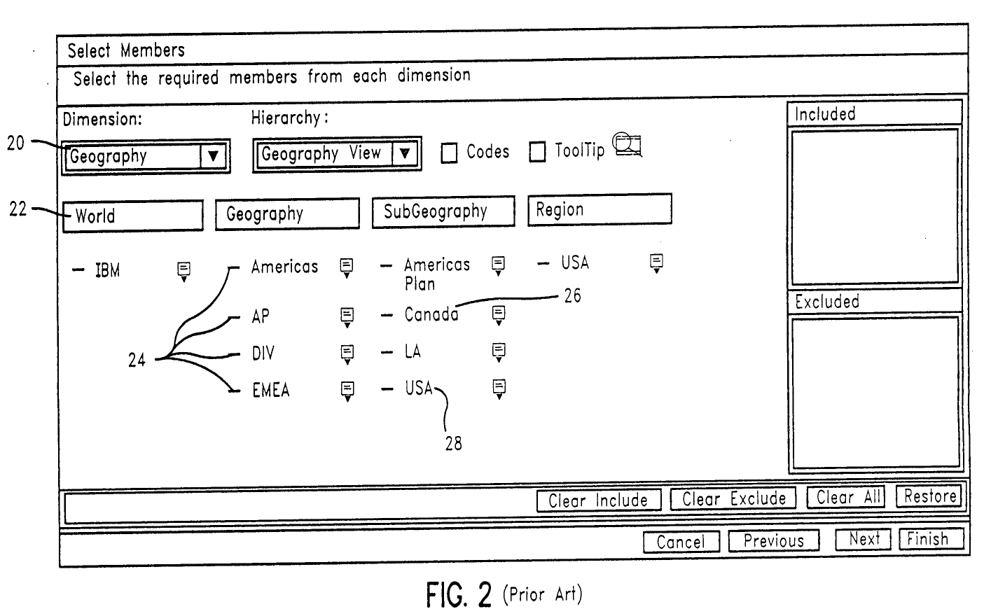

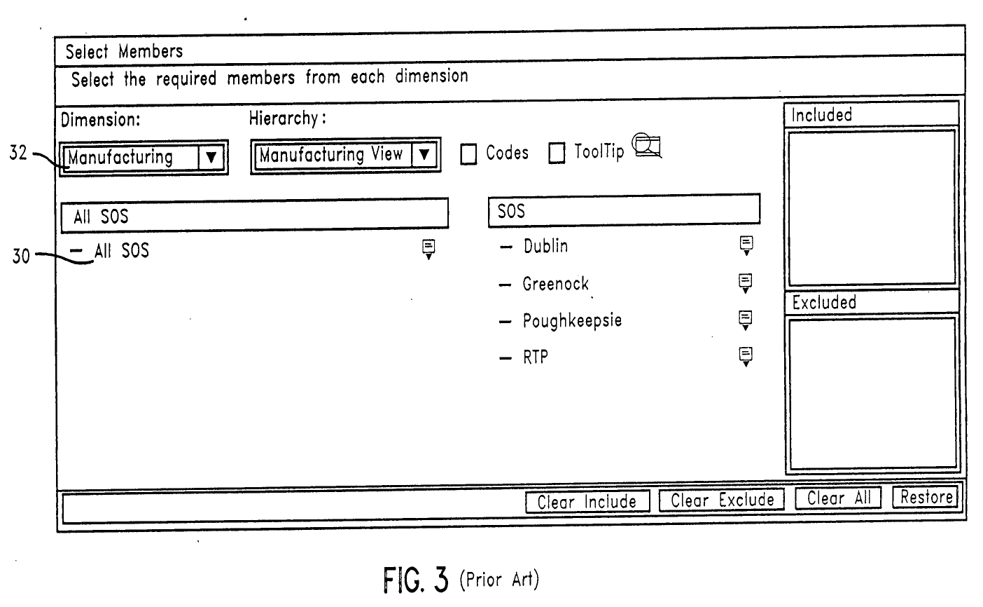

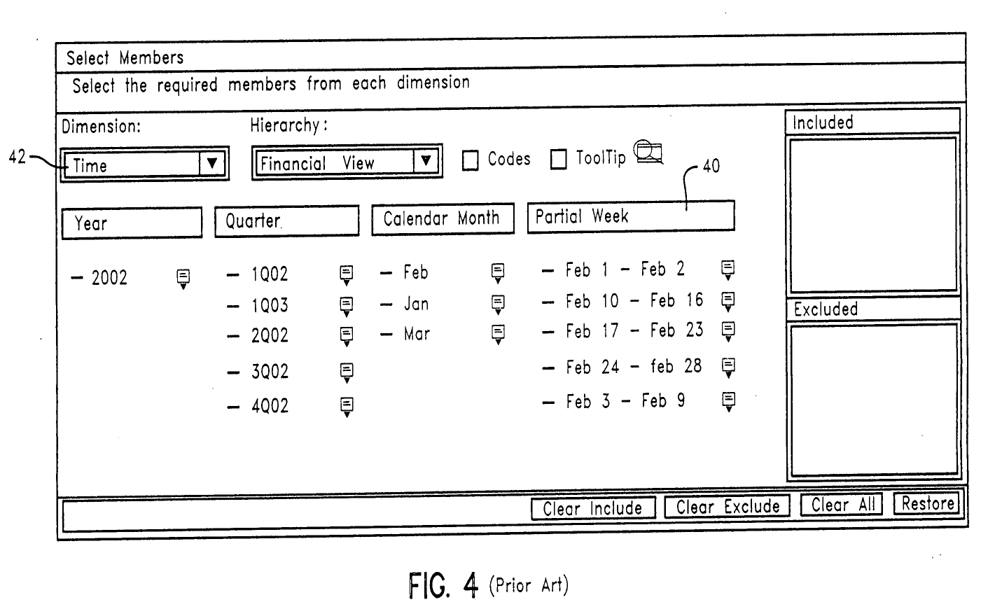

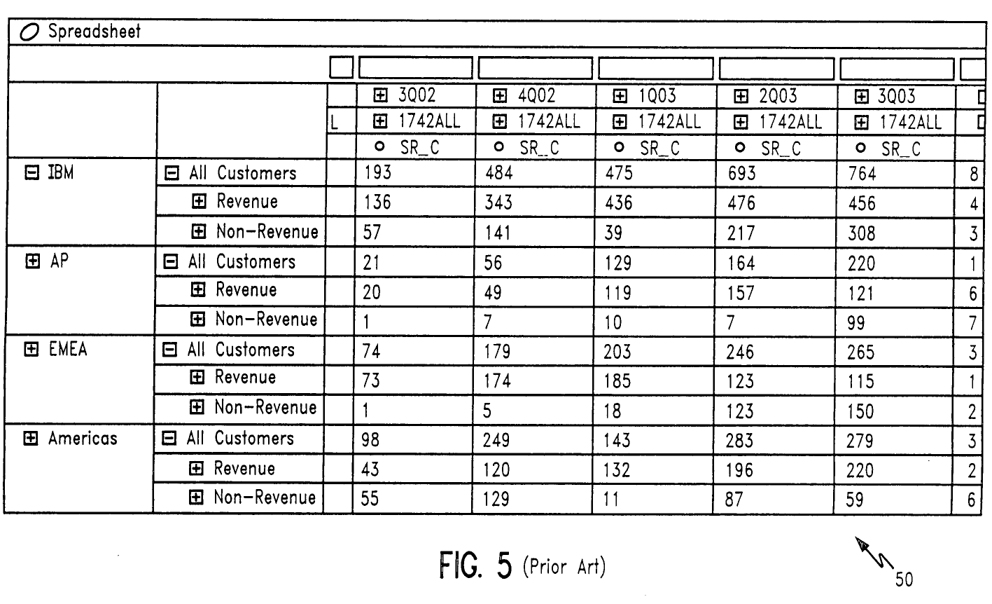

In describing the preferred embodiment of the present invention, reference will be made herein to FIGS. 1-18 of the drawings in which like numerals refer to like features of the invention.

The present invention automates: 1) the creation and maintenance of an i2 Demand Manager database; 2) the retrieval of data from source systems; 3) the formatting of the data automatically based on how the data measures are defined; and 4) the loading of the data into the i2 application underlying DB/2 tables.

In an i2 Demand Manager application, the persistence and measure databases described above must be built and loaded with data on a periodic basis.

Currently, building the database requires manual creation of many large XML files, as well as SQL which must be supplied to the i2 components so it is known how to retrieve data from the measure data tables, which are defined in i2dmdb. The XML files have pointers to other XML files. Depending on the number of data measures available, the XML files will normally be very large. Manual creation and maintenance of these is time consuming and extremely error prone. Moreover, when there is a change to the database schema, including, for example, adding new measures or changing how a measure is defined, the entire XML file must be changed manually. Again, this is very time consuming and error prone. Also, the SQL will need to be changed. The complexity of the SQL prohibits easy modification. Furthermore, creating the SQL for the first time is time consuming, and error prone due to the manual nature of the data entry.

The second necessary function is loading the databases. Each measure typically has its data reside in a table, independent of whether the application is Oracle based or DB/2 based. Depending on how the measure is keyed for a given dimension or a given level in the dimension, the format for each table will be different. To load each table, a program or SQL must know the format of the table, so that the proper SQL can be created to accommodate the insert statements for the table.

The present invention automates the creation of all the inputs to building the database. It also automates the loading of the data into the measure data tables. Importantly, all the data needed to create the databases, as well as the SQL, is stored in configuration tables. Programs read the tables and generate the XML files as well as the SQL. When changes have to be made to the databases, including adding dimensions, measures, or changing the dimensionality of measures, it is only the configuration tables that need to be updated. This updating process is performed in a timely manner when compared to the manual updating of the data files as currently performed in the prior art. The programs that generate the XML and SQL are then activated. If the configuration tables are correct, the XML and SQL will match and work together. This represents an automated rebuild of the database.

After the database schema is built for the first time, or rebuilt when changes such as those listed above are performed, the data for all measures has to be loaded into the database. Programs are generated to read the same configuration tables to get the schema for the data table for the measure being loaded. When the program knows the schema, the SQL can be created to do the inserts for the data for the measure.

Control tables are also generated to control data loading, concerning such functions as which measures get loaded, when they get loaded, and the like.

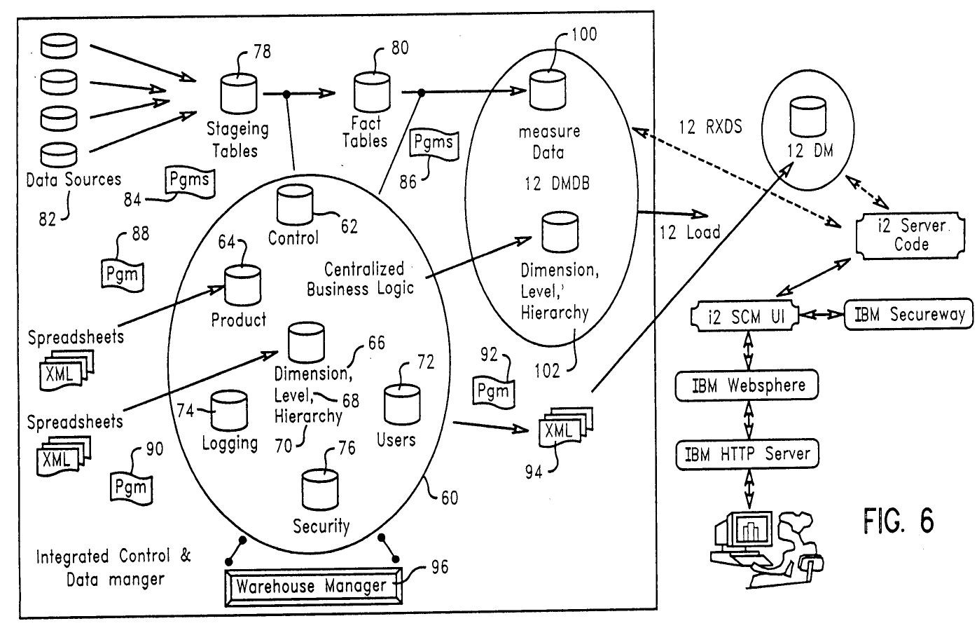

FIG. 6 depicts the Integrated Control and Data Manager 60 of the present invention. Numerous configuration tables are generated. These include control tables 62, product tables 64, dimension tables 66, level tables 68, hierarchy tables 70, user ID tables 72, logging tables 74, and security tables 76. Programs 92 are designed to read from these tables and automatically produce the XML 94 and SQL files needed to build or rebuild the database for the i2 Demand Manager. By employing this automated data entry and retrieval application, a change to the database schema simply requires a change or changes to one or more of the tables. Once the tables are generated, a script is run to execute the programs to generate all the files to build or rebuild the database.

The measure data resides in staging tables 78 and fact tables 80. These tables receive input from various data sources 82. The present invention includes programs 84 to input this data to the Integrated Control and Data Manger (ICDM) 60. Programs 86 are generated to load the data into the measure data tables 100 of the i2 Demand Manager Database 102. Importantly, this suite of programs access the same tables in the ICDM 60 to load data that other programs use to build the database. The data retrieval and loading is tightly integrated, assuring for quick, error free building/rebuilding of the Demand Manager database, and quick, error free, data loading that lends itself to customization.

Programs 88 and 90 are generated to input spreadsheet information into the ICDM 60 for the product tables 64, dimension tables 66, level tables 68, and hierarchy tables 70. A warehouse manager 96 interfaces with the ICDM 60 for data storage and retrieval functions.

Inputs to Building the i2 Persistence Database

The Persistence Database is built using an i2 utility called i2DMutils. This utility takes a configuration file, named i2DM.cfg, as an input. This file references, among other things, many XML files, which define the database. The XML files are converted into the metadata mentioned above and loaded into the i2dm database. The XML files will need to be generated or created. In addition to the XML files, the Demand Manager server code needs the location of the data for each measure, such as database and table locations. The persistence database is referred to as i2dm, and the tables that contain the data for the measures are referred to an icdm database. In order to build the Demand Manager database, the build utility must be provided, including all the information, such as SQL statements, that the server code will need to retrieve the measure data. This information (SQL) is stored in a file, called src.sql, and is executed when the database is being built.

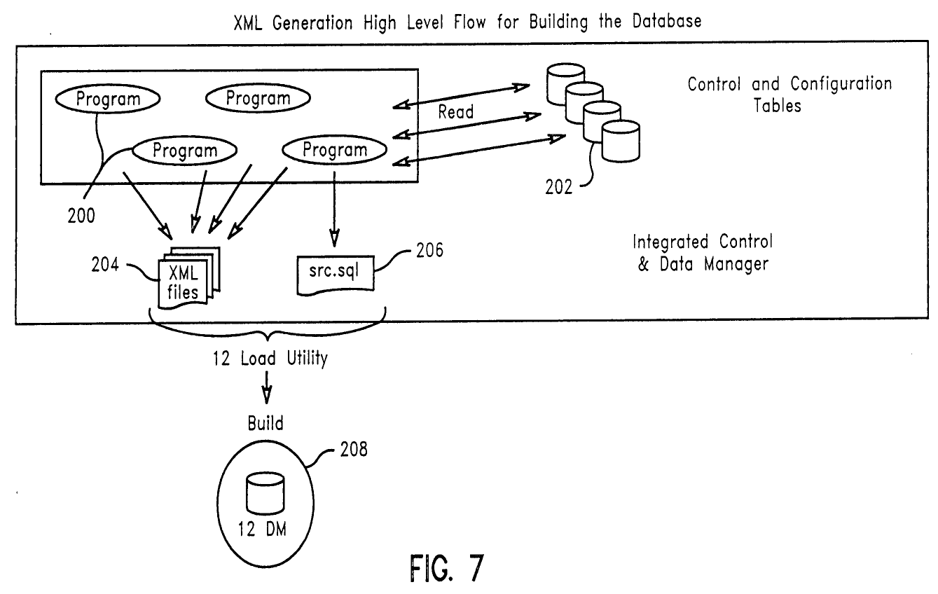

Referring to FIG. 7, the Integrated Control and Data Manager contains a number of programs 200 which all read the control and configuration tables 202 in the ICDM to generate the XML files 204 and SQL files 206 that are inputted into the i2 utility 208 to build the database.

Some of the XML and SQL files, which have to be created to build or rebuild the Demand Manager database, are given in the Tables below. In all cases, these represent small excerpts of a complete file.

The i2DM cfg File

This file gets created when the i2 server code is installed. The install procedure requires information such as the location for the middleware components, and the DB/2 aliases for the database, to name a few. The format of the file is depicted in Table I below.

TABLE 1
A Sample Portion Of An i2dm.cfg File

[ENVIRONMENT]
APPLICATION=LSP
RDBMS=DB2
SID=i2dm390
PERSISTENCEDATAMODEL=i2dm390
DBUSER=i2dm
DBPASSWD=000007009143091159018172233041
DAWROOT=/home/i2dm/DMBlue6.0
DAWBIN=/home/i2dm/DMBlue6.0/bin
DAWADMIN=/home/i2dm/DMBlue6.0/admin
XMLPATH=/home/i2dm/DMBlue6.0/admin
VISIBROKERBIN=/opt/vbroker4.5/lib/../bin
VBJPATH=/opt/vbroker4.5/lib
JDKPATH=/usr/java131
SCHEMA_FOLDER=/home/i2dm/DMBlue6.0/contrxds/schema
XTERM_PATH=/home/i2dm/DMBlue6.0/bin
XWIN=Y
DMDB=Y
NAMEROOT=corbaroot
NAMEPORT=14000
INSTANCENAME=DMpok390
ARCHITECTURE=32
INTERACTIVE=Y

An ADF section calls out the XML files which are used to build/define the database. These XML files must be created. They are text files which can be manually edited, but doing so is highly error prone. Data in the files points to data in other files. Some of the files are also very large. A sample portion of an ADFs section of the i2dm.cfg file is given in Table II below.

TABLE II
ADFs Portion Of The i2dm.cfg File

[ADFS]
DBCREATE=persist.xml
CREATE=create.xml
LOAD=load.xml
SOURCE_GROUP=srcrep.xml
SOURCES=src.xml
SOURCE_GROUP_USER=srcauth.xml
XDSTARGETS=xdstargets.xml
DAW_USERS=users.xml
USER_SECURITY=usersecurity.xml
CUSTOMGROUPS=customgroups.xml
DOMAINS=domains.xml
CURRENT_TIME=curtime.xml
UICONFIG=i2DM.xml

XML Files for Defining and Building the Database

XML files are used for defining and building the database. A partial of one such file, named create.xml, is shown below. This is the file that defines the skeleton of the database: the dimensions, levels, and measures. This is only a very small sample of the xml file. A complete file would be much larger. It would necessarily contain information for every measure in the database. The sample below, shown in Table III, does not show any measure information; only dimension information is exhibited.

TABLE III
Sample XML File For Defining And Building The Database

<?xml version=“1.0”?>
<!-- Generated by ctl.create_xml.cmd on 020503 -->

<DEPLOYMENT>
<METADATA OPTYPE=“CREATE”>

<BASEDIMENSION NAME=“Customer”>

<DESCRIPTION>Customer Dimension</DESCRIPTION>

| | | |
|---|---|---|
| <LEVEL NAME=“All Customers” | DISKTHRESHOLD=“4” | INMEMTHRESHOLD=“4” |

CODEWIDTH=“1”>

<DESCRIPTION>Level - All Customers</DESCRIPTION>

<PARENT></PARENT>

</LEVEL>

| | | | |
|---|---|---|---|
| <LEVEL | NAME=“Customer | Segment” | DISKTHRESHOLD=“4” |

INMEMTHRESHOLD=“4” CODEWIDTH=“1”>

<DESCRIPTION>Level - Customer Segment</DESCRIPTION>

<PARENT>All Customers</PARENT>

</LEVEL>

| | | |
|---|---|---|
| <LEVEL NAME=“Customer Type” | DISKTHRESHOLD=“4” | INMEMTHRESHOLD=“4” |

CODEWIDTH=“1”>

<DESCRIPTION>Level - Customer Type</DESCRIPTION>

<PARENT>Customer Segment</PARENT>

</LEVEL>

| | | | |
|---|---|---|---|
| <LEVEL | NAME=“Channel” | DISKTHRESHOLD=“4” | INMEMTHRESHOLD=“4” |

CODEWIDTH=“1”>

<DESCRIPTION>Level - Channel</DESCRIPTION>

<PARENT>Customer Segment</PARENT>

</LEVEL>

| | | |
|---|---|---|
| <LEVEL NAME=“End Customer” | DISKTHRESHOLD=“4” | INMEMTHRESHOLD=“4” |

CODEWIDTH=“3”>

<DESCRIPTION>Level - End Customer</DESCRIPTION>

<PARENT>Customer Type</PARENT>
<PARENT>Channel</PARENT>

</LEVEL>

</BASEDIMENSION>
<BASEDIMENSION NAME=“Geography”>

<DESCRIPTION>Geography Dimension</DESCRIPTION>

| | | | |
|---|---|---|---|
| <LEVEL | NAME=“World” | DISKTHRESHOLD=“4” | INMEMTHRESHOLD=“4” |

CODEWIDTH=“1”>

<DESCRIPTION>Level - World</DESCRIPTION>

<PARENT></PARENT>

</LEVEL>

| | | |
|---|---|---|
| <LEVEL NAME=“Geography” | DISKTHRESHOLD=“4” | INMEMTHRESHOLD=“4” |

CODEWIDTH=“1”>

<DESCRIPTION>Level - Geography</DESCRIPTION>

<PARENT>World</PARENT>

</LEVEL>

| | | |
|---|---|---|
| <LEVEL NAME=“SubGeography” | DISKTHRESHOLD=“4” | INMEMTHRESHOLD=“4” |

CODEWIDTH=“1”>

<DESCRIPTION>Level - SubGeography</DESCRIPTION>

<PARENT>Geography</PARENT>

</LEVEL>

| | | | |
|---|---|---|---|
| <LEVEL | NAME=“Region” | DISKTHRESHOLD=“4” | INMEMTHRESHOLD=“4” |

CODEWIDTH=“2”>

<DESCRIPTION>Level - Region</DESCRIPTION>

<PARENT>SubGeography</PARENT>

</LEVEL>

| | | | |
|---|---|---|---|
| <LEVEL | NAME=“Country” | DISKTHRESHOLD=“4” | INMEMTHRESHOLD=“4” |

CODEWIDTH=“3”>

<DESCRIPTION>Level - Country</DESCRIPTION>

<PARENT>Region</PARENT>

</LEVEL>

</BASEDIMENSION>

<BASEDIMENSION NAME=“Product”>

<DESCRIPTION>Product Dimension</DESCRIPTION>

| | | | |
|---|---|---|---|
| <LEVEL | NAME=“Brand” | DISKTHRESHOLD=“4” | INMEMTHRESHOLD=“4” |

CODEWIDTH=“1”>

<DESCRIPTION>Level - Brand</DESCRIPTION>

<PARENT></PARENT>

</LEVEL>

| | | | | |
|---|---|---|---|---|
| <LEVEL | NAME=“Summary | Level | 5” | DISKTHRESHOLD=“4” |

INMEMTHRESHOLD=“4”CODEWIDTH=“2”>

<DESCRIPTION>Level - Summary Level 5</DESCRIPTION>

<PARENT>Brand</PARENT>

</LEVEL>

| | | | | |
|---|---|---|---|---|
| <LEVEL | NAME=“Summary | Level | 4” | DISKTHRESHOLD=“4” |

INMEMTHRESHOLD=“4”CODEWIDTH=“3”>

<DESCRIPTION>Level - Summary Level 4</DESCRIPTION>

<PARENT>Summary Level 5</PARENT>

</LEVEL>

| | | | | |
|---|---|---|---|---|
| <LEVEL | NAME=“Summary | Level | 3” | DISKTHRESHOLD=“4” |

INMEMTHRESHOLD=“4”CODEWIDTH=“3”>

<DESCRIPTION>Level - Summary Level 3</DESCRIPTION>

<PARENT>Summary Level 4</PARENT>

</LEVEL>

| | | | | |
|---|---|---|---|---|
| <LEVEL | NAME=“Summary | Level | 2” | DISKTHRESHOLD=“4” |

INMEMTHRESHOLD=“4”CODEWIDTH=“4”>

<DESCRIPTION>Level - Summary Level 2</DESCRIPTION>

<PARENT>Summary Level 3</PARENT>

</LEVEL>

| | | | | |
|---|---|---|---|---|
| <LEVEL | NAME=“Summary | Level | 1” | DISKTHRESHOLD=“4” |

INMEMTHRESHOLD=“4”CODEWIDTH=“4”>

<DESCRIPTION>Level - Summary Level 1</DESCRIPTION>

<PARENT>Summary Level 2</PARENT>

</LEVEL>

| | | |
|---|---|---|
| <LEVEL NAME=“Planning Item” | DISKTHRESHOLD=“4” | INMEMTHRESHOLD=“4” |

CODEWIDTH=“14”>

<DESCRIPTION>Level - Planning Item</DESCRIPTION>

<PARENT>Summary Level 1</PARENT>

</LEVEL>

</BASEDIMENSION>

<TIMEDIMENSION NAME=“Time”>

<DESCRIPTION>Time Dimension</DESCRIPTION>

| | | | |
|---|---|---|---|
| <LEVEL | NAME=“Year” | DISKTHRESHOLD=“4” | INMEMTHRESHOLD=“4” |

CODEWIDTH=“4”>

<DESCRIPTION>Level - Year</DESCRIPTION>

<PARENT></PARENT>

</LEVEL>

| | | | |
|---|---|---|---|
| <LEVEL | NAME=“Quarter” | DISKTHRESHOLD=“4” | INMEMTHRESHOLD=“4” |

CODEWIDTH=“4”>

<DESCRIPTION>Level - Quarter</DESCRIPTION>

<PARENT>Year</PARENT>

</LEVEL>

| | | |
|---|---|---|
| <LEVEL NAME=“Mfg Month” | DISKTHRESHOLD=“4” | INMEMTHRESHOLD=“4” |

CODEWIDTH=“4”>

<DESCRIPTION>Level - Mfg Month</DESCRIPTION>

<PARENT></PARENT>

</LEVEL>

| | | |
|---|---|---|
| <LEVEL NAME=“Calendar Month” | DISKTHRESHOLD=“4” | INMEMTHRESHOLD=“4” |

CODEWIDTH=“4”>

<DESCRIPTION>Level - Calendar Month</DESCRIPTION>

<PARENT>Quarter</PARENT>

</LEVEL>

| | | |
|---|---|---|
| <LEVEL NAME=“Mfg Week” | DISKTHRESHOLD=“4” | INMEMTHRESHOLD=“4” |

CODEWIDTH=“4”>

<DESCRIPTION>Level - Mfg Week</DESCRIPTION>

<PARENT>Mfg Month</PARENT>

</LEVEL>

| | | |
|---|---|---|
| <LEVEL NAME=“Partial Week” | DISKTHRESHOLD=“4” | INMEMTHRESHOLD=“4” |

CODEWIDTH=“4”>

<DESCRIPTION>Level - Partial Week</DESCRIPTION>

<PARENT>Calendar Month</PARENT>
<PARENT>Mfg Week</PARENT>

</LEVEL>

</TIMEDIMENSION>

There are a number of requirements that must be followed when generating this type of file. For example, the dimension names must start with the letters A-S, thus assuring the TIME dimension comes last. Also, this file must adhere to XML standards. One such standard is that certain characters are treated differently, for instance, if the measure name has an ampersand (&) in it, the program must generate the text as “&amp.” The XML parser will interpret the “&amp” as “&.” The programs that exist in the ICDM must adhere to these standards.

The second part of this file details the measures and how they are defined. An exemplary partial file (only one measure) is shown in Table IV below.

TABLE IV
Partial XML File For Detailing And Defining Measures

| | |
|---|---|
| <MEASURE | NAME=“Backlog_(Cust_&amp;_Cust_Order_2_Dimensions)” |

TYPE=“BIMEASURE” LOCKABLE=“FALSE”>

<DESCRIPTION>Backlog (Cust &amp; Cust Order 2 Dimensions)</DESCRIPTION>

<MEASUREDIMENSION DIMENSION=“Customer1”>

<UPPERBOUND>All Customers_3</UPPERBOUND>
<LOWERBOUND>Customer Type_3</LOWERBOUND>

</MEASUREDIMENSION>
<MEASUREDIMENSION DIMENSION=“Customer2”>

<UPPERBOUND>All Channels</UPPERBOUND>
<LOWERBOUND>End Customer_4</LOWERBOUND>

</MEASUREDIMENSION>
<MEASUREDIMENSION DIMENSION=“Geography”>

<UPPERBOUND>World</UPPERBOUND>
<LOWERBOUND>Country</LOWERBOUND>

</MEASUREDIMENSION>
<MEASUREDIMENSION DIMENSION=“Manufacturing”>

<UPPERBOUND>All SOS</UPPERBOUND>
<LOWERBOUND>SOS</LOWERBOUND>

</MEASUREDIMENSION>
<MEASUREDIMENSION DIMENSION=“MCustomer Order1”>

<UPPERBOUND>All Delivery Options</UPPERBOUND>
<LOWERBOUND>Delivery Option_7</LOWERBOUND>

</MEASUREDIMENSION>
<MEASUREDIMENSION DIMENSION=“MCustomer Order2”>

<UPPERBOUND>All Orders</UPPERBOUND>
<LOWERBOUND>Type Of Order_8</LOWERBOUND>

</MEASUREDIMENSION>
<MEASUREDIMENSION DIMENSION=“MUpgrades”>

<UPPERBOUND>All Mach Upg</UPPERBOUND>
<LOWERBOUND>SrcGen</LOWERBOUND>

</MEASUREDIMENSION>
<MEASUREDIMENSION DIMENSION=“MVersions”>

<UPPERBOUND>Version</UPPERBOUND>
<LOWERBOUND>Version</LOWERBOUND>

</MEASUREDIMENSION>
<MEASUREDIMENSION DIMENSION=“Product1”>

<UPPERBOUND>Brand_11</UPPERBOUND>
<LOWERBOUND>Planning Item_11</LOWERBOUND>

</MEASUREDIMENSION>
<MEASUREDIMENSION DIMENSION=“Time” SPECIAL=“TRUE”>

<UPPERBOUND>Year</UPPERBOUND>
<LOWERBOUND>Partial Week</LOWERBOUND>
<AGGREGATETYPE>SUM</AGGREGATETYPE>

</MEASUREDIMENSION>

<DATATYPE TYPE=“NUM” WIDTH=“7” DECIMAL=“0” SIGN=“POS”/>

</MEASURE>

The load.xml File

An load.xml file is required to load the hierarchy instances into the i2 DM database. This file contains the targets to be loaded and is placed in an administration directory. A sample file is shown in Table V. A program exists in the ICDM application of the present invention to generate this file.

TABLE V
Sample load.xml File

<?xml version=“1.0”?>
<!-- Generated by load1.cmd -->
<DEPLOYMENT>

<XDS OPTYPE=“LOAD”>
<!-- Customer -->

<TARGET TARGET=“TARGET AH Customers”/>
<TARGET TARGET=“TARGET Customer Segment”/>
<TARGET TARGET=“TARGET Customer Type”/>
<TARGET TARGET=“TARGET Channel”/>
<TARGET TARGET=“TARGET End Customer”/>

<!-- Customer1 -->

<TARGET TARGET=“TARGET All Customers_3”/>
<TARGET TARGET=“TARGET Customer Segment_3”/>
<TARGET TARGET=“TARGET Customer Type_3”/>

<!-- Customer2 -->

<TARGET TARGET=“TARGET All Channels”/>
<TARGET TARGET=“TARGET Channel_4”/>
<TARGET TARGET=“TARGET End Customer_4”/>

<!-- Geography -->

<TARGET TARGET=“TARGET World”/>
<TARGET TARGET=“TARGET Geography”/>
<TARGET TARGET=“TARGET SubGeography”/>
<TARGET TARGET=“TARGET Region”/>
<TARGET TARGET=“TARGET Country”/>

<!-- Manufacturing -->

<TARGET TARGET=“TARGET All SOS”/>
<TARGET TARGET=“TARGET SOS”/>

<!-- MCustomer Order -->

<TARGET TARGET=“TARGET All Customer Orders”/>
<TARGET TARGET=“TARGET Delivery Option”/>
<TARGET TARGET=“TARGET Summary Of Order”/>
<TARGET TARGET=“TARGET Type Of Order”/>

<!-- MCustomer Order1 -->

<TARGET TARGET=“TARGET All Delivery Options”/>
<TARGET TARGET=“TARGET Delivery Option_7”/>

<!-- MCustomer Order2 -->

<TARGET TARGET=“TARGET All Orders”/>
<TARGET TARGET=“TARGET Summary Of Order_8”/>
<TARGET TARGET=“TARGET Type Of Order_8”/>

<!-- MUpgrades -->

<TARGET TARGET=“TARGET All Mach Upg”/>
<TARGET TARGET=“TARGET Mach Upg”/>
<TARGET TARGET=“TARGET SrcGen”/>

<!-- MVersions -->

<TARGET TARGET=“TARGET Version”/>

<!-- Product -->

<TARGET TARGET=“TARGET Brand”/>
<TARGET TARGET=“TARGET Summary Level 5”/>
<TARGET TARGET=“TARGET Summary Level 4”/>
<TARGET TARGET=“TARGET Summary Level 3”/>
<TARGET TARGET=“TARGET Summary Level 2”/>
<TARGET TARGET=“TARGET Summary Level 1”/>
<TARGET TARGET=“TARGET Planning Item”/>

<!-- Product 1 -->

<TARGET TARGET=“TARGET Brand_11”/>
<TARGET TARGET=“TARGET Summary Level 5_11”/>
<TARGET TARGET=“TARGET Summary Level 4_11”/>
<TARGET TARGET=“TARGET Summary Level 3_11”/>
<TARGET TARGET=“TARGET Summary Level 2_11”/>
<TARGET TARGET=“TARGET Summary Level 1_11”/>
<TARGET TARGET=“TARGET Planning Item_11”/>

<!-- Sub Product -->

<TARGET TARGET=“TARGET FeatSum”/>
<TARGET TARGET=“TARGET Feature”/>

<!-- Time -->

<TARGET TARGET=“TARGET Year”/>
<TARGET TARGET=“TARGET Quarter”/>
<TARGET TARGET=“TARGET Mfg Month”/>
<TARGET TARGET=“TARGET Calendar Month”/>
<TARGET TARGET=“TARGET Mfg Week”/>

</XDS>

</DEPLOYMENT>

XML Files for Defining Users and User Security

XML files are needed for defining users and user security. These files include, but are not limited to, those files needed to define users and groups of users, security files for dimensions, levels, measures, and domains, custom groups created in the i2 Demand Manager to grant hierarchy member security, and an XML file to create domains, to name a few.

The users.xml File

This file is used to define users and groups of users. The present invention includes a program that is written to generate this file. A sample file is depicted in Table VI below.

TABLE VI
Sample User XML File

<?xml version=“1.0”?>
<!-- Generated by Lazy Utils on 29 Jan 2003 -->
<DEPLOYMENT>
<SECURITY OPTYPE=“CREATE”>

<USER NAME= “alberto” PASSWORD= “alberto” ADMIN =
“TRUE”/>
<USER NAME= “allingm” PASSWORD= “allingm” ADMIN =
“TRUE”/>
<USER NAME= “alviti” PASSWORD= “alviti” ADMIN =
“TRUE”/>
<GROUP NAME = “everyone”>

<USER>alberto</USER>
<USER>allingm</USER>
<USER>alviti</USER>

</GROUP>

</SECURITY>
</DEPLOYMENT></DEPLOYMENT>

The usersecurity.xml File

In the i2 Demand Manager architecture, a user has no initial access rights to any object. Access rights need to be granted to the user for dimensions, levels, measures, and domains (for level instances and measure data). Table VII represents excerpts from a preferred usersecurity.xml file. Access rights are given to dimensions, levels, measures, measure data. The present invention includes a program to generate a user security XML file.

TABLE VII
Excerpt Of usersecurity.xml File

<?xml version=“1.0”?>
<!-- Generated by Lazy Utils on 29 Jan 2003 -->
<DEPLOYMENT>

<SECURITY OPTYPE=“ADD”>

<ACCESSRIGHTS TYPE=“DIMENSION”>

<DIMENSION>Customer</DIMENSION>
<PERMISSION NAME=“READ”>

<GROUP>everyone</GROUP>

</PERMISSION>

</ACCESSRIGHTS>
<ACCESSRIGHTS TYPE=“DIMENSION”>

<DIMENSION>Customer1</DIMENSION>
<PERMISSION NAME=“READ”>

<GROUP>everyone</GROUP>

</PERMISSION>

</ACCESSRIGHTS>
<ACCESSRIGHTS TYPE=“LEVEL”>

<LEVEL NAME=“All Customers” DIMENSION=“Customer”/>
PERMISSION NAME=“READ”>

<GROUP>everyone</GROUP>

</PERMISSION>

</ACCESSRIGHTS>
<ACCESSRIGHTS TYPE=“LEVEL”>

<LEVEL NAME=“Customer Segment” DIMENSION=“Customer”/>
<PERMISSION NAME=“READ”>

<GROUP>everyone</GROUP>

</PERMISSION>

</ACCESSRIGHTS>
<ACCESSRIGHTS TYPE=“MEMBER”>

<DIMENSION>Customer</DIMENSION>
<DOMAIN>Customer Domain</DOMAIN>
<PERMISSION NAME=“READ”>

<GROUP>everyone</GROUP>

</PERMISSION>
<PERMISSION NAME=“GRANT”>

<USER>dawadmin</USER>

</PERMISSION>

</ACCESSRIGHTS>
<ACCESSRIGHTS TYPE=“MEMBER”>

<DIMENSION>Customer1</DIMENSION>
<DOMAIN>Customer1 Domain</DOMAIN>
<PERMISSION NAME=“READ”>

<GROUP>everyone</GROUP>

</PERMISSION>
<PERMISSION NAME=“GRANT”>

<USER>dawadmin</USER>

</PERMISSION>

</ACCESSRIGHTS>
<ACCESSRIGHTS TYPE=“MEASURE”>

<MEASURE>Backlog (Cust&amp;Cust Order 2 Dimensions)</MEASURE>
<PERMISSION NAME=“READ”>

<GROUP>everyone</GROUP>

</PERMISSION>

</ACCESSRIGHTS>
<ACCESSRIGHTS TYPE=“MEASURE”>

<MEASURE>Backlog (Cust&amp;Cust Order 2 Views)</MEASURE>
<PERMISSION NAME=“READ”>

<GROUP>everyone</GROUP>

</PERMISSION>

</ACCESSRIGHTS>
<ACCESSRIGHTS TYPE=“DATA”>

<MEASURE>Metric 1 Value</MEASURE>
<DOMAIN>Measure Geography Product Product 1 Time Domain</DOMAIN>
<PERMISSION NAME=“READ”>

<GROUP>everyone</GROUP>

</PERMISSION>

</ACCESSRIGHTS>
<ACCESSRIGHTS TYPE=“DATA”>

<MEASURE>Ships from SOS (Cust&amp;Cust Order 2 Views)</MEASURE>
<DOMAIN>Measure Customer Customer Order Geography MUpgrades

Manufacturing Product1 Time Domain</DOMAIN>

<PERMISSION NAME=“READ”>

<GROUP>everyone</GROUP>

</PERMISSION>

</SECURITY>

</DEPLOYMENT>

The customgroups.xml File

Custom groups may also need to be created in the i2 Demand Manager to grant hierarchy member security, and thereby grant access to a subset of the entire hierarchy. Custom groups can be viewed as sub-trees within a hierarchy. Each has a root level, an upper bound level, and a lower bound level. Once a custom group is created, domains are defined and users or groups are given access to the defined domain. An XML file is required to create custom groups. This file contains definitions of the custom groups in terms of the root, upper bound, and lower bound levels. The present invention includes a program to generate this file. By its nature, this file could potentially become very large. Specific member instance codes have to be specified as detailed with the “MEMBER CODE” parameter shown below. Table VIII depicts a sample portion of a customgroups.xml file.

TABLE VIII
Sample portion of a customsgroups.xml File

<?xml version=“1.0”?>
<!-- Generated by Lazy Utils on 29 Jan 2003 -->
<DEPLOYMENT>

<METADATA OPTYPE=“CREATE”>

<CUSTOMGROUP NAME=“CG 1 All Customers” DESCRIPTION=“1 All Customers

Customer Dimension Custom Group”>

<SCOPE DIMENSION=“Customer”>

<MEMBER CODE=“1” LEVEL=“All Customers”>
</MEMBER>
<UPPERBOUND>All Customers</UPPERBOUND>
<LOWERBOUND>End Customer</LOWERBOUND>

</SCOPE>

</CUSTOMGROUP>
<CUSTOMGROUP NAME=“CG 1 All Customers_3” DESCRIPTION=“1 All

Customers_3 Customer1 Dimension Custom Group”>

<SCOPE DIMENSION=“Customer1”>

<MEMBER CODE=“1” LEVEL=“All Customers_3”>
</MEMBER>
<UPPERBOUND>All Customers_3</UPPERBOUND>
<LOWERBOUND>Customer Type_3</LOWERBOUND>

</SCOPE>

</CUSTOMGROUP>

</METADATA>

</DEPLOYMENT>

The domains.xml File

As noted above, domains are a logical grouping of custom groups from one or more dimensions to which i2 Demand Manager users are granted access rights. Preferably, domains are created after custom groups, and consist of custom groups previously generated. A domain needs to be created for controlling access to hierarchy members and data measures. This is done to give users access to these measures in the context of those custom groups. Domains that are used for granting access to hierarchy members comprise custom groups that belong only to one dimension. For data measures, the domains should comprise a combination of custom groups—one from each dimension, and should make up the dimensionality of that measure. The present invention requires an XML file to create domains. This file contains definitions of the domain in terms of a collection of custom groups. Table IX depicts a sample section of a domains.xml file for the present invention.

TABLE IX
A Sample Section Of A domains.xml File

<?xml version=“1.0”?>
<DEPLOYMENT>

<METADATA OPTYPE=“CREATE”>

<DOMAIN NAME =“Customer Domain”>

<BASEDIMENSION>Customer</BASEDIMENSION>
<CUSTOMGROUP>CG 1 All Customers</CUSTOMGROUP>

</DOMAIN>
<DOMAIN NAME =“Customer1 Domain”>

<BASEDIMENSION>Customer1</BASEDIMENSION>
<CUSTOMGROUP>CG 1 All Customers_3</CUSTOMGROUP>

</DOMAIN>
<DOMAIN NAME =“Measure Geography Product Product1 Time Domain”>

<CUSTOMGROUP>CG 1 World</CUSTOMGROUP>
<CUSTOMGROUP>CG 1 Brand</CUSTOMGROUP>
<CUSTOMGROUP>CG 2 Brand</CUSTOMGROUP>
<CUSTOMGROUP>CG 3 Brand</CUSTOMGROUP>
<CUSTOMGROUP>CG 1 Brand_11</CUSTOMGROUP>
<CUSTOMGROUP>CG 2 Brand_11</CUSTOMGROUP>
<CUSTOMGROUP>CG 3 Brand_11</CUSTOMGROUP>
<CUSTOMGROUP>CG 2002 Year</CUSTOMGROUP>

</DOMAIN>
<DOMAIN NAME =“Measure Customer Customer Order Geography Mupgrades

Manufacturing Product1 Time Domain”>

<CUSTOMGROUP>CG 1 All Customers</CUSTOMGROUP>
<CUSTOMGROUP>CG 1 All Customer Orders</CUSTOMGROUP>
<CUSTOMGROUP>CG 1 World</CUSTOMGROUP>
<CUSTOMGROUP>CG 1 All SOS</CUSTOMGROUP>
<CUSTOMGROUP>CG 1 All Mach Upg</CUSTOMGROUP>
<CUSTOMGROUP>CG 1 Brand_11</CUSTOMGROUP>
<CUSTOMGROUP>CG 2 Brand_11</CUSTOMGROUP>
<CUSTOMGROUP>CG 3 Brand_11</CUSTOMGROUP>
<CUSTOMGROUP>CG 2002 Year</CUSTOMGROUP>

</DOMAIN>

</METADATA>

</DEPLOYMENT>

Other XML Files

The remaining XML files required for database build and setup include files to set the current date for the application, to load the default hierarchies and cube definitions, and to generate the SQL to retrieve and insert measure data from the measure data tables. These files are further delineated below.

The curtime.xml File

This file sets the current date for the application. A program exists to generate this file, and runs nightly at 12:01 AM to reset the current time token in the i2 Demand Manager. Table X depicts a sample curtime.xml file.

TABLE X
Sample curtime.xml File.

<?xml version=“1.0”?>
<!-- Generated by Lazy Utils on 27 Jan 2003 -->
<DEPLOYMENT>

<METADATA OPTYPE=“SET”>

<TIMEPERIOD DIMENSION=“Time”>

<MEMBER CODE=“0201” LEVEL=“Partial Week”>
</MEMBER>

</TIMEPERIOD>

</METADATA>

</DEPLOYMENT>

The i2DMxml File

Once the meta data has been loaded into the i2 Demand Manager, the default hierarchies and cube definitions are loaded, along with role definitions for different users. The default hierarchies represent a starting point for grouping levels into logical aggregation paths. The cube definitions group the i2 Demand Manager measures in terms of behavior, such as bi-measure, single point, and the like, and data import levels. Role definitions are used to allow individual users to perform different tasks, such as defining scopes, creating favorites folders, among others, and to restrict specific users from the same. A program exists in the present invention to generate this file.

The src.sql File

The src.sql file is the critical link between the persistence database and the measure data tables. The file is necessary for building the database, and must contain the SQL to retrieve and insert measure data from the measure data tables. Preferably, the src.sql file contains two sections, one that defines the SQL for the dimensions, and one defining the SQL for the measures. A sample part of the dimension SQL in this file is shown in Table XI. The SQL requires the codes for the dimensions and contains the dimension level entries. Preferably, there would be one section for every level for every dimension.

TABLE XI
Sample Portion Of src.sql File

-- Level name = “World”
INSERT INTO SYSTARGETS(TRGTID, TRGT, MTYPENAME) VALUES (10, ‘World’,
‘XDSMEMBERLOAD’);
INSERT INTO SYSTARGETMEMBERS(TRGTID, MEMBERNAME, COLLECTIONSIZE,
COLUMNNAMES, SUBKEY_SEP) VALUES (10, ‘ancestor_codes’, 0, ‘’, ‘:’);
INSERT INTO SYSSOURCE(SRCID, SOURCENAME, TRGTID) VALUES (10, ‘World’, 10);
INSERT INTO SYSSOURCESTMT(SRCID, STMTTYPE, KEYID, SQLSTATEMENT)
VALUES (10, 1, 0, ‘SELECT DISTINCT WORLD_LABEL, WORLD_CODE FROM
LVL.DIM_GEO’);
-- Level name = “Geography”
INSERT INTO SYSTARGETS(TRGTID, TRGT, MTYPENAME) VALUES (11, ‘Geography’,
‘XDSMEMBERLOAD’);
INSERT INTO SYSTARGETMEMBERS(TRGTID, MEMBERNAME, COLLECTIONSIZE,
COLUMNNAMES, SUBKEY_SEP) VALUES (11, ‘ancestor_codes’, 1, ‘World’, ‘:’);
INSERT INTO SYSSOURCE(SRCID, SOURCENAME, TRGTID) VALUES (11, ‘Geography’,
11);
INSERT INTO SYSSOURCESTMT(SRCID, STMTTYPE, KEYID, SQLSTATEMENT)
VALUES (11, 1, 0, ‘SELECT DISTINCT GEO_LABEL, GEO_CODE , WORLD_CODE FROM
LVL.DIM_GEO’);
-- Level name = “Delivery Option_7”
INSERT INTO SYSTARGETS(TRGTID, TRGT, MTYPENAME) VALUES (71, ‘Delivery
Option_7’, ‘XDSMEMBERLOAD’);
INSERT INTO SYSTARGETMEMBERS(TRGTID, MEMBERNAME, COLLECTIONSIZE,
COLUMNNAMES, SUBKEY_SEP) VALUES (71, ‘ancestor_codes’, 1, ‘All Delivery Options’,
‘:’);
INSERT INTO SYSSOURCE(SRCID, SOURCENAME, TRGTID) VALUES (71, ‘Delivery
Option_7’, 71);
INSERT INTO SYSSOURCESTMT(SRCID, STMTTYPE, KEYID, SQLSTATEMENT)
VALUES (71, 1, 0, ‘SELECT DISTINCT DEL_OPT_7_LABEL, DEL_OPT_7_CODE ,
A_DEL_OP_CODE FROM LVL.DIM_CUSTOMER_ORDER1’);
-- Level name = “All Orders”
INSERT INTO SYSTARGETS(TRGTID, TRGT, MTYPENAME) VALUES (80, ‘All Orders’,
‘XDSMEMBERLOAD’);
INSERT INTO SYSTARGETMEMBERS(TRGTID, MEMBERNAME, COLLECTIONSIZE,
COLUMNNAMES, SUBKEY_SEP) VALUES (80, ‘ancestor_codes’, 0, ‘’, ‘:’);
INSERT INTO SYSSOURCE(SRCID, SOURCENAME, TRGTID) VALUES (80, ‘All Orders’,
80);
INSERT INTO SYSSOURCESTMT(SRCID, STMTTYPE, KEYID, SQLSTATEMENT)
VALUES (80, 1, 0, ‘SELECT DISTINCT ALL_ORD_LABEL, ALL_ORD_CODE FROM
LVL.DIM_CUSTOMER_ORDER2’);
-- Level name = “Summary Of Order_8”
INSERT INTO SYSTARGETS(TRGTID, TRGT, MTYPENAME) VALUES (81, ‘Summary Of
Order_8’, ‘XDSMEMBERLOAD’);
INSERT INTO SYSTARGETMEMBERS(TRGTID, MEMBERNAME, COLLECTIONSIZE,
COLUMNNAMES, SUBKEY_SEP) VALUES (81, ‘ancestor_codes’, 1, ‘All Orders’, ‘:’);
INSERT INTO SYSSOURCE(SRCID, SOURCENAME, TRGTID) VALUES (81, ‘Summary Of
Order_8’, 81);
INSERT INTO SYSSOURCESTMT(SRCID, STMTTYPE, KEYID, SQLSTATEMENT)
VALUES (81, 1, 0, ‘SELECT DISTINCT SUM_OR_8_LABEL, SUM_OR_8_CODE ,
ALL_ORD_CODE FROM LVL.DIM_CUSTOMER_ORDER2’);
A sample part of the measure SQL in this file, for one measure only:
-- Measure name = “Load_(Cust_&_Cust_Order_2_Dimensions)”
INSERT INTO SYSTARGETS(TRGTID, TRGT, MTYPENAME) VALUES ( 10009,
‘Load_(Cust_&_Cust_Order_2_Dimensions)’, ‘XDSDATALOADDOUBLE’);
INSERT INTO SYSTARGETMEMBERS(TRGTID, MEMBERNAME, COLLECTIONSIZE,
COLUMNNAMES, SUBKEY_SEP) VALUES (10009, ‘code’, 9, ‘Customer Type_3:End
Customer_4:Country:SOS:Delivery Option_7:Type Of Order_8:SrcGen:Version:Planning
Item_11’, ‘:’);
INSERT INTO SYSSOURCE(SRCID, SOURCENAME, TRGTID) VALUES (10009,
‘Load_(Cust_&_Cust_Order_2_Dimensions)’, 10009);
INSERT INTO SOURCESTMTCOLS (SRCID, CATEGORY, IDX, COLNAME, COLTYPE)
SELECT 10009, ‘KEY’, 2, ‘CUS_TYP_3_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 3, ‘END_CUS_4_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 4, ‘CTRY_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 5, ‘SOS_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 6, ‘DEL_OPT_7_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 7, ‘TYP_OR_8_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 8, ‘SRCGEN_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 9, ‘VERSION_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 10, ‘PLN_I_11_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘KEY’, 11, ‘PART_WK_CODE’, TYPEID FROM SQLTYPES WHERE
TYPENAME=‘CHAR’;
INSERT INTO SOURCESTMTCOLS (SRCID, CATEGORY, IDX, COLNAME, COLTYPE)
SELECT 10009, ‘MEASURE’, 1, ‘QUANTITY’, TYPEID FROM SQLTYPES WHERE
TYPENAME=‘DOUBLE’;
INSERT INTO SYSSOURCESTMT (SRCID, STMTTYPE, KEYID, SQLSTATEMENT)
SELECT 10009, E1.CONSTID, E2.CONSTID, ‘SELECT DISTINCT CUS_TYP_3_CODE,
END_CUS_4_CODE, CTRY_CODE, SOS_CODE, DEL_OPT_7_CODE, TYP_OR_8_CODE,
SRCGEN_CODE, VERSION_CODE, PLN_I_11_CODE, PART_WK CODE FROM
FCT_LOAD_CRAD_1’ FROM ENUMS E1, ENUMS E2 WHERE E1.ENUMNAME =
‘STMTTYPE’ AND E1.CONSTNAME = ‘SELECT’ AND E2.ENUMNAME = ‘KEYTYPE’ AND
E2.CONSTNAME = ‘BYVALUE’;
INSERT INTO SYSSOURCESTMT (SRCID, STMTTYPE, KEYID, SQLSTATEMENT)
SELECT 10009, E1.CONSTID, E2.CONSTID, ‘UPDATE FCT_LOAD_CRAD_1 SET
QUANTITY = ? WHERE CUS_TYP_3_CODE = ? AND END_CUS_4_CODE = ? AND
CTRY_CODE = ? AND SOS_CODE = ? AND DEL_OPT_7_CODE = ? AND
TYP_OR_8_CODE = ? AND SRCGEN_CODE = ? AND VERSION_CODE = ? AND
PLN_I_11_CODE = ? AND PART_WK_CODE = ?_’ FROM ENUMS E1, ENUMS E2 WHERE
E1.ENUMNAME = ‘STMTTYPE’ AND E1.CONSTNAME = ‘UPDATE’ AND E2.ENUMNAME
= ‘KEYTYPE’ AND E2.CONSTNAME = ‘BYVALUE’;
INSERT INTO SYSSOURCESTMT (SRCID, STMTTYPE, KEYID, SQLSTATEMENT)
SELECT 10009, E1.CONSTID, E2.CONSTID, ‘INSERT INTO FCT_LOAD_CRAD_1 (
CUS_TYP_3_CODE, END_CUS_4_CODE, CTRY_CODE, SOS_CODE, DEL_OPT_7_CODE,
TYP_OR_8_CODE, SRCGEN_CODE, VERSION_CODE, PLN_I_11_CODE,
PART_WK_CODE) VALUES ( ?, ?, ?, ?, ?, ?, ?, ?, ?, ?)’ FROM ENUMS E1, ENUMS E2
WHERE E1.ENUMNAME = ‘STMTTYPE’ AND E1.CONSTNAME = ‘APPEND’ AND
E2.ENUMNAME = ‘KEYTYPE’ AND E2.CONSTNAME = ‘BYVALUE’;

As seen from Table XI, this SQL file is complex, and will be lengthy when complete. The sample given in Table XI is for one measure only. A single typographical error would cause the database to not be built. The present invention includes a program to generate the SQL based on the measure and dimension tables.

Building the aforementioned files is timely, labor intensive, and conducive to error. The slightest mistake or typographical error will result in the database not getting built.

The present invention introduces a set of configuration tables (CONFIG tables) and programs to facilitate the database build. The tables are populated with data from the user and typically include all the hierarchy, level, and measure data. Programs are generated to read from these tables and generate the necessary files to build the databases.

Control tables and programs are also created to control the scheduling and loading of data into the Demand Manager database to update the measure data tables, as well as to control and house the business logic that is needed to convert and configure the incoming source data to meet the business requirements.

Dimension Configuration Tables

Dimension configuration tables are generated to handle the dimension information. Configuration includes a master dimension source table, a table for holding the views, a table for holding hierarchy level information for each dimension, a table containing information relating to each level, such as the size of the level, so programs can read it to create the xml files to build the database, a table containing information for each measure, a table holding the dimensionality information for each measure, a table holding the lookup information that the Demand Manager server code requires to locate where to get the data for the single point measures, a table to handle level members, a table to hold data for the intersections of the database, a table containing user ID and password information, as well as security information, a table to hold each process, a table to hold each events of processes, a table containing information for each measure regarding loading of the source data, a table for forecast measure initialization, a table containing products that the user would want data on for forecasting, and a table containing logi,c which programs will read to convert the source data into data that can be loaded into the i2 Demand Manager.

The dim.dimension_master Configuration Table

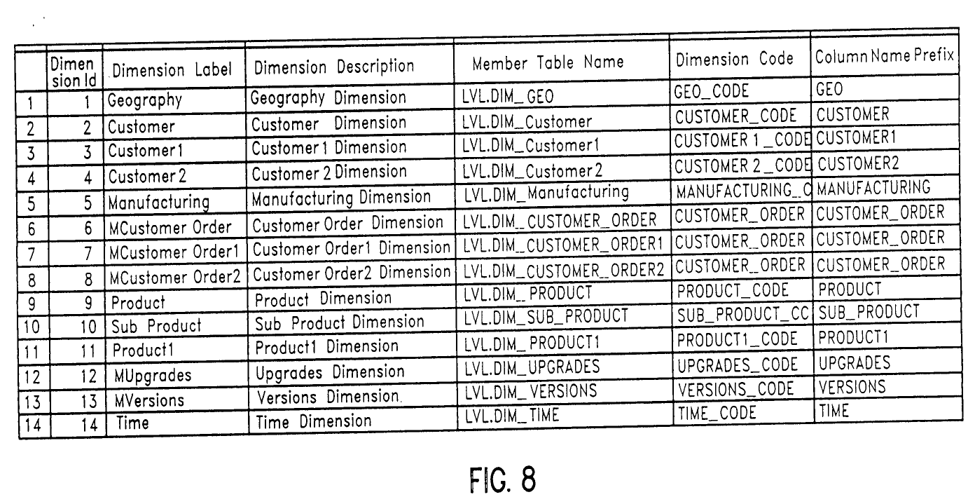

This table represents the master dimension source. It contains the database dimensions, the table name which holds the specific instances that are in each dimension, as well as other information that programs will read to create the XML files to build the database. A sample of some data of the master dimension source is depicted in FIG. 8. This table holds the data for the dimensions of the database.

The dim.dimension_view Configuration Table

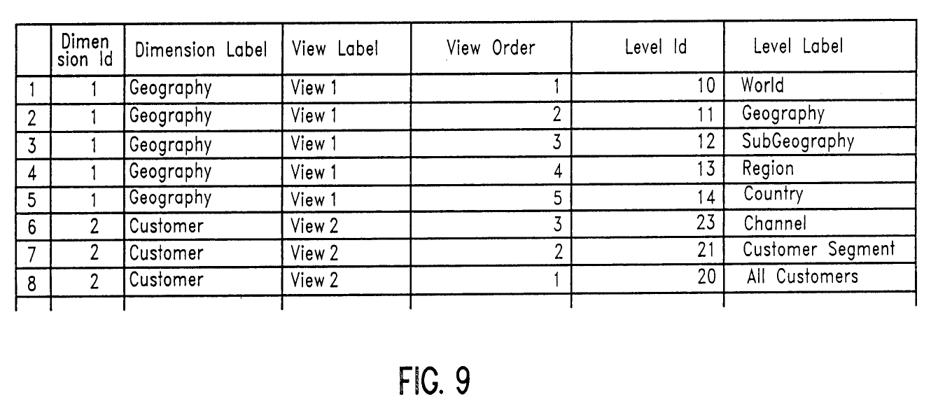

The dim.dimension_view configuration table holds the views of the database. Each dimension must have at least one view. The present invention creates programs that read from this table and create the database. Using the view order and level ID columns, the view to the user can be determined. FIG. 9 depicts a sample portion of the dim.dimension_view configuration table of the present invention.

The dim.level_hierarchy Configuration Table

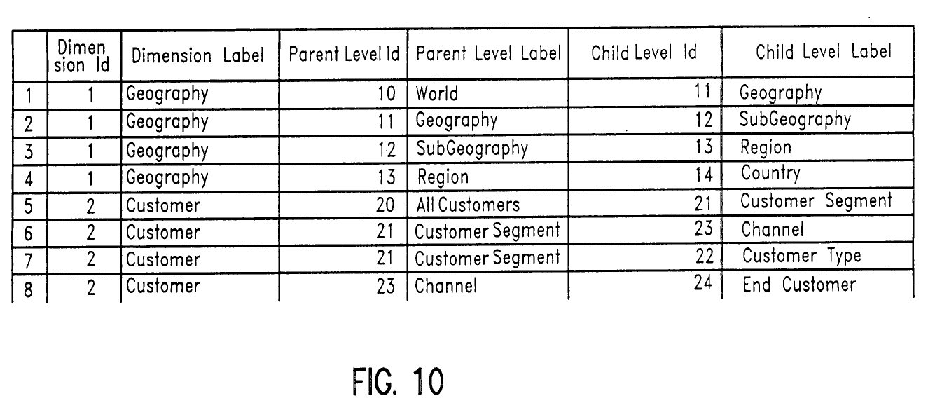

This table holds the hierarchy level information for each dimension. Programs are designed to read this table to generate the skeleton of the database, for example, the parent/child pairs for the levels. FIG. 10 depicts a sample portion of the dim.level_hierarchy configuration table.

The dim.level_master Configuration Table

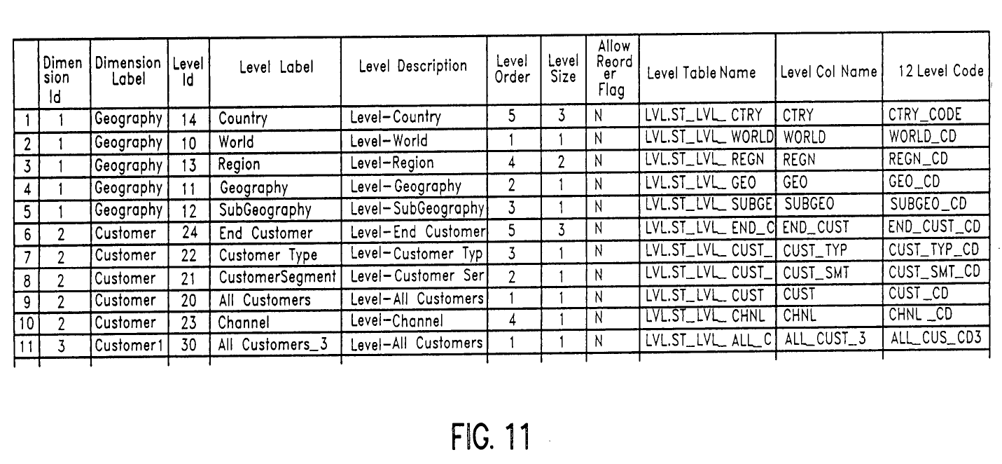

The dim.level_master table is the master level source. It contains information relating to each level, such as the size of the level, so programs can read it to create the xml files to build the database. FIG. 11 depicts a sample portion of the dim.level_master configuration table of the present invention.

The Measure Configuration Tables

The measure.measure_master Configuration Table

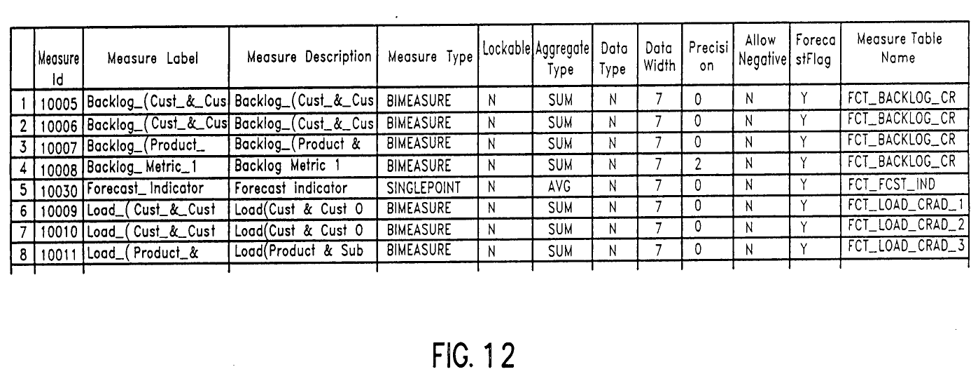

The measure.measure_master configuration table is the master measure source. It contains information for each measure, including the type, for example, bi-measure or single point, data width, precision, and the like. These are values that are required to build the XML files for the database creation. FIG. 12 depicts a sample portion of the measure.measure_master configuration table of the present invention.

The measure.measure_dimensionality Configuration Table

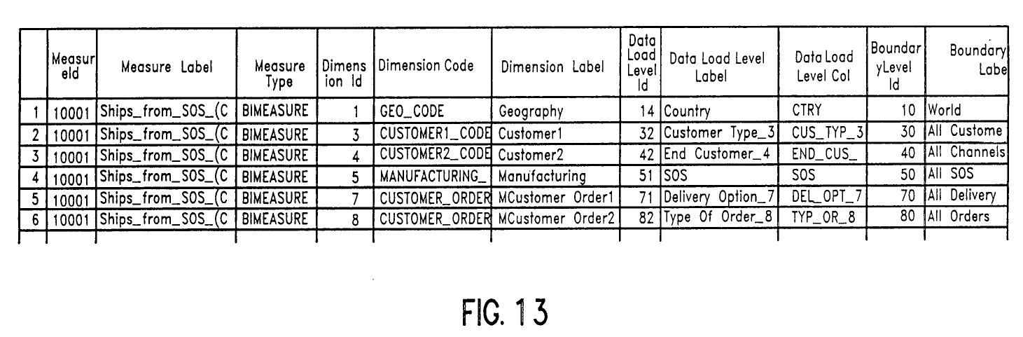

The measure.measure_dimensionality configuration table holds the dimensionality information for each measure, such as which dimensions the measure is keyed, how far down the dimension the measure is keyed, and the like. The configuration table is used by programs in the database build process. FIG. 13 depicts a sample portion of the measure.measure_dimensionality configuration table.

The measure.measure_lookup Configuration Table

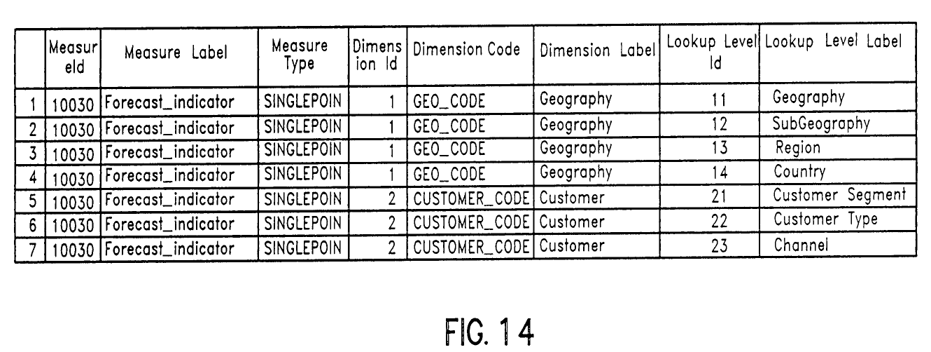

The measure.measure_lookup configuration table is used for single point measures. This configuration table holds the lookup information that the Demand Manager server code requires in order to locate the data for the single point measures. FIG. 14 depicts a sample portion of a measure.measure_lookup configuration table.

Level Tables

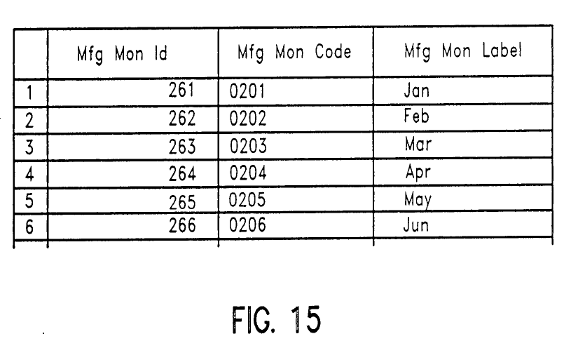

Level tables are configured to address level members, that is, specific instances of each level. Every level for every dimension must have a table. FIG. 15 represents an example of the lvl.st_lvl_mfg_month tables.

Measure Data Tables

Measure data tables are configured to hold the data for the intersections of the database. This is the data the user would see in Demand Manager, as well as the tables that get updated when the user clicks the “Update Database” button in Demand Manager.

Each measure in the Demand Manager is stored in its own table, because every measure could potentially be keyed at different dimensions and different levels within those dimensions. The table name for each measure is stored in the measure.measure_master table referenced above. The measure data tables are preferably prefixed with the qualifier “DATA.” For example, the table that holds the data for the Backlog by CRAD measure might be named DATA.Backlog_CRAD.

The creation of the measure data tables requires a significant manual and potentially error-prone effort since each measure is unique. Consequently, the present invention relies on programs which read from the measure.measure_master table and measure.measure_dimensionality table to automatically generate SQL that then generates every table.

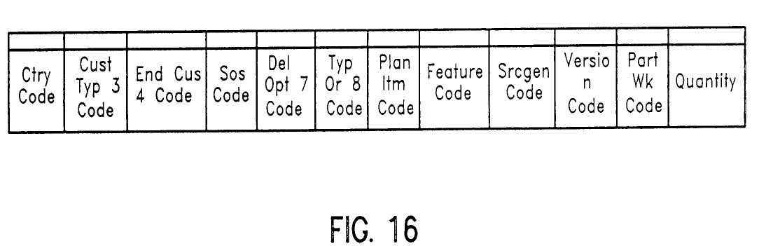

A sample measure data table file is depicted in FIG. 16. Preferably, the tables will have different columns depending on the measure that is being stored in it. For example, whatever measure is being stored in the table must be keyed to each of the dimensions and the dimension's level below, that is, at the Country level of the Country dimension, the Cust Typ 3 level of the Customer dimension, and the End Cust 4 level of the End Customer dimension, and so on. Each data table will have the QUANTITY column at the end.

User Security Tables

User security tables contain user ID and password information, as well as security information, such as data measures, domains, and other information a user has access to view and update.

Logger Tables

Logger tables are used to log either a process or a program execution. Two tables are used: LOGGER.LOG_PROCESS and LOGGER.LOG_PROCESS_EVENTS. The tables are tied together with a process ID.

The LOGGER.LOG_PROCESS Table

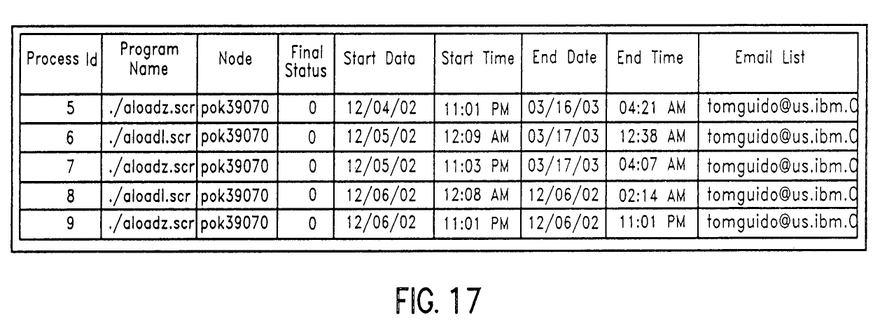

The LOGGER.LOG_PROCESS table is designed to hold each process. A single entry is placed in the table for a process that is initiated. The process may have many events, which are stored in the table. The table preferably has information such as the process name, server node it ran on, final status, start date/time, and a list of email identifications to send status. APIs are written, from which programs will call to place entries in the tables. FIG. 17 depicts a sample portion of the logger.log_process table.

The LOGGER.LOG_PROCESS_EVENTS Table

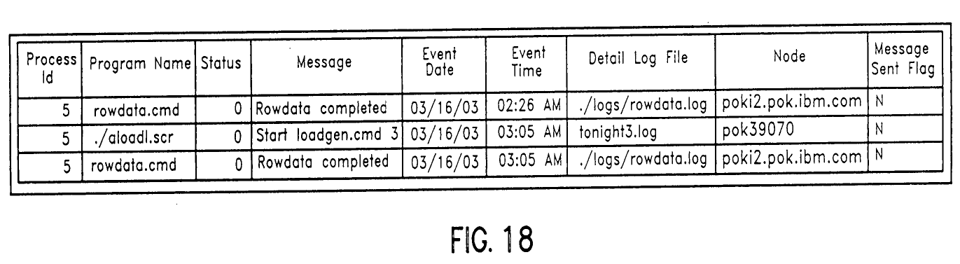

The LOGGER.LOG_PROCESS_EVENTS table holds events of processes. An event can represent any form of instruction or data, even a program of a process. The table has a column listing the detail log file for troubleshooting or other purposes. FIG. 18 depicts a sample portion of the LOGGER.LOG_PROCESS_EVENTS table.

Data Load Tables

The data load tables contain information for each measure regarding loading of source data, such as a calendar for each day to determine which measures are to get data refreshed, as well as the date range for data refresh. Programs are generated to read from these tables to determine which data has to be loaded into the Demand Manager database. The programs read from “fact” tables, mentioned below.

Forecast Measure Initialization

Forecast Measures are those measures which users input data for their forecasts. These measures are initialized so that the user is able to update them. Their intersections are valid for the dimensions defined in the database. The present invention provides a program to read the measure dimensionality tables and generate the initialization files, which are CSV files imported into the measure data tables. The intersections are preferably initialized with zeroes.

Product Tables

The product tables contain the products for which the user requires data for forecasting. The products in these tables are loaded into the Demand Manager database as part of the Product dimension. There is an automated product menu process provided to read an incoming spreadsheet from the customer, processes it, and update the tables. The data in the tables is then loaded into the Demand Manager database.

Business Logic Tables

Data for measure is sourced from a mainframe database or other alternate source. Once the data is inputted, it is manipulated to fit into the database hierarchy of dimensions, measures, and the like. This process is referred to as business logic. The business logic tables contain logic which program is provided to read in order to convert the source data into data that can be loaded into the Demand Manager. These programs take the data from the source tables, apply business logic, and update fact tables. The fact tables contain the data in a format that can be loaded into the Demand Manager database.

The present invention primarily concerns computer program codes and their execution. In another aspect of this invention, the compilation of program codes creates a computer program product comprising: a computer usable medium having computer readable program code means embodied therein for causing a method for generating a set of tables and programs to automate the creation and recreation of an i2 Demand Manager database application, the computer readable program code means in the computer program product comprise: computer readable program code means for: causing a computer to effect building i2 Demand Manager persistence and measure databases, including creating SQL and generating a first set of programs to retrieve data from source systems; causing a computer to effect storing the data in configuration tables during the building; causing a computer to effect activating a second set of programs to read the configuration tables and create XML files and SQL statements; causing a computer to effect formatting the data based on defined data measures; and causing a computer to effect loading the data into the i2 Demand Manager database. Generally architectural hardware is available to store and run these program codes.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method for automating the creation and maintenance of an i2 Demand Manager database, comprising:
building i2 Demand Manager persistence and measure databases, including creating SQL and generating a first set of programs to retrieve data from source systems;
storing said data in configuration tables;
activating a second set of programs to read said configuration tables and create XML files and SQL statements;
formatting said data based on defined data measures; and
loading said data into said i2 Demand Manager database.

2. The method of claim 1 wherein loading said data further comprises generating control tables to control said loading, including determining which of said data measures are to be loaded and when loading occurs.

3. The method of claim 1 wherein said configuration tables further include: control, product, dimension, level, hierarchy, user ID, logging, and security tables.

4. The method of claim 1 further comprising running a script to execute said first and second set of programs.

5. The method of claim 1 including inputting said XML files into an i2 utility to build said i2 Demand Manager database.

6. The method of claim 1 wherein said programs input measure data for said measure database, said measure data residing in staging tables and fact tables.

7. The method of claim 3 including inputting spreadsheet information into said product tables, dimension tables, level tables, and hierarchy tables.

8. The method of claim 1 including generating and providing a warehouse manager program to facilitate data storage and retrieval.

9. The method of claim 1 further comprising building said persistence database using an i2 utility program, such that said configuration files are inputs to said i2 utility program.

10. The method of claim 9 including referencing said XML files in said configuration files, converting said XML files to meta data, and providing said i2 utility program with said SQL statements.

11. The method of claim 10 further including installing said configuration files including installing information for location for middleware components and DB/2 aliases.

12. The method of claim 1 wherein said XML file defines a skeleton of said database, including dimension, levels, and measures.

13. The method of claim 1 wherein loading said data into said i2 Demand Manager database includes generating a load file for loading hierarchy instances and targets, and placing said load file in an administrative directory.

14. The method of claim 3 wherein said dimension table includes:
a master dimension source table;
a table holding views;
a table holding hierarchy level information for each dimension;
a table containing information to each level;
a table containing information to each measure;
a table holding lookup information for location;
a table holding information for level members;
a table holding data for intersections of said database;
tables containing user ID, password, and security information; and
tables holding each process and each event of each process.

15. The method of claim 1 further including generating measure configuration tables comprising:
generating a master measure source table;
holding dimensionality information for each of said measures;
addressing level members; and
generating measure data tables.

16. The method of claim 15 including generating programs to read said master measure source table and said dimensionality information, said programs automatically generate SQL for said tables.

17. The method of claim 3 further including generating logger tables to log process or program execution, data loading tables, and forecast measure initialization tables.

18. A computer program product comprising:
a computer usable medium having computer readable program code means embodied therein for causing a method for generating a set of tables and programs to automate the creation and recreation of an i2 Demand Manager database application, the computer readable program code means in said computer program product comprising:
computer readable program code means for causing a computer to effect building i2 Demand Manager persistence and measure databases, including creating SQL and generating a first set of programs to retrieve data from source systems;
computer readable program code means for causing a computer to effect storing said data in configuration tables during said building;
computer readable program code means for causing a computer to effect activating a second set of programs to read said configuration tables and create XML files and SQL statements;
computer readable program code means for causing a computer to effect formatting said data based on defined data measures; and
computer readable program code means for causing a computer to effect loading said data into said i2 Demand Manager database.

19. The computer program product of claim 18 including computer readable program code means for generating said configuration tables further comprising: control, product, dimension, level, hierarchy, user ID, logging, and security tables.

20. The computer program product of claim 18 including computer readable program code means for inputting said XML files into an i2 utility to build said i2 Demand Manager database.
